(19) United States
(12) Patent Application Publication
(10) Pub. No.: US 2023/0177406 A1
(43) Pub. Date: Jun. 8, 2023

(54) DEVICE AND METHOD FOR INTERPRETING A PREDICTING OF AT LEAST ONE FAILURE OF A SYSTEM

(71) Applicant: AKTIEBOLAGET SKF, Goteborg (DE)

(72) Inventors: Yosef HAMMER, Nahalal (IL); Michal GOLAN, Haifa (IL)

(21) Appl. No.: 17/986,319

(22) Filed: Nov. 14, 2022

(30) Foreign Application Priority Data
Dec. 7, 2021 (DE) 102021213868.3
Jan. 11, 2022 (DE) 102022200199.0

(51) Int. Cl. G06N 20/20

(52) U.S. Cl. CPC G06N 20/20

(57) ABSTRACT

A method for interpreting a prediction of at least one failure of a system includes collecting a set of parameters representative of an operation of the system during a training period before a failure occurs, identifying at least two combinations of at least two parameters of the set of parameters occurring before the failure, determining a probability of occurrence of the at least two combinations, ranking the at least two combinations of at least two parameters according to the probability, monitoring the set of parameters when the system is operating outside the training period, implementing the trained machine learning algorithm with the monitored set of parameters to identify the at least one failure, and issuing the combination of the at least of two parameters before failure having the highest probability of occurrence of the at least two combinations of the at least two parameters.

### CROSS-REFERENCE

This application claims priority to German patent application no. 10 2022 200 199.0 filed on Jan. 11, 2022, and German patent application no. 10 2021 213 868.3 filed on Dec. 7, 2021, the contents of which are fully incorporated herein by reference.

### TECHNOLOGICAL FIELD

The present disclosure is directed to predicting failures of systems and more particularly to a device and a method for interpreting a prediction of failures of systems.

### BACKGROUND

Generally, a black box model is used for predicting failures of a system. The black box model issues an alarm to point out a risk of failure. However, such a black box model does not give any explanation about the kind of predicted failure and does not issue any recommendation.

### SUMMARY

Consequently, the present disclosure is intended to overcome these disadvantages.

According to an aspect of the disclosure a method is disclosed for interpreting a prediction of at least one failure of a system.

The method comprises includes:

collecting a set of parameters representative of the operation of the system preceding the occurrence of at the least one failure during a training period,

using a trained machine learning algorithm to identify the time before the at least one failure occurs, the time before the failure occurs being the sampling time before the failure occurs,

identifying at least two combinations of at least two parameters of the set of parameters occurring before the appearance of the at least one failure during the training period from the identified time before the at least one failure occurs,

determining the probability of occurrence of the at least two combinations of the at least two parameters before the appearance of the at least one failure from the set of parameters during the training period,

ranking the at least two combinations of at least two parameters according to their probability of occurrence during the training period,

monitoring the set of parameters of the system when the system is operating outside the training period, and

implementing the trained machine learning algorithm with the monitored set of parameters to identify the at least one failure when the system is operating outside the training period, and

issuing the combination of the at least two parameters before failure having the highest probability of occurrence of the at least two combinations of the at least two parameters, the combination of the at least two parameters matching the monitored set of parameters if the machine learning algorithm identifies the said failure.

The method permits the kind of failure to be determined from the detected parameter combination indicative of a type of failure based on the history of the system before the failure appears on the system to issue the combination of parameters indicative of the type of failure. The determination of type of failure and the probability of occurrence of the failure permits predictions to be issued for example in order to schedule preventive maintenance operations.

Preferably, if the machine learning algorithm identifies the at least one failure, the method comprises generating an alert comprising the combination of at least two parameters having the highest probability of occurrence before the at least one failure occurs. Advantageously, if the alert is generated, preventive maintenance operations are scheduled.

Preferably, the machine learning algorithm comprises a random forest machine learning algorithm. Advantageously, collecting a set of parameters comprises receiving the set of parameters measured by at least one sensor.

According to another aspect, a device is disclosed for interpreting a prediction of at least one failure of a system.

The device comprises:

collecting means for collecting a set of parameters representative of the operation of the system during which the system preceding the occurrence of at the least one failure during a training period,

using means for using a trained machine learning algorithm to identify the time before the at least one failure occurs, the time before the failure occurs being the sampling time before the failure occurs,

identifying means for identifying at least two combinations of parameters of the set of parameters occurring before the appearance of the at least one failure during the training period from the identified time before the at least one failure occurs,

determining means for determining the probability of occurrence of the at least two combinations of the at least two parameters before the appearance of the at least one failure from the set of parameters during the training period,

ranking means for ranking the at least two combinations of at least two parameters according to their probability of occurrence during the training period,

monitoring means for monitoring the set of parameters of the system when the system is operating outside the training period,

implementing means for implementing the trained machine learning algorithm with the monitored set of parameters to identify the at least one failure when the system is operating outside the training period, and

issuing means for issuing the combination of the at least two parameters before failure having the highest probability of occurrence of the at least two combinations of the at least two parameters, the combination of the at least two parameters matching the monitored set of parameters if the machine learning algorithm identifies the said failure.

Preferably, the device comprises warning means for generating an alert comprising the combination of at least two parameters having the highest probability of occurrence before the at least one failure occurs if the machine learning algorithm identifies the at least one failure.

Advantageously, each parameter is represented by a mathematical set of at least one value, the said at least two combinations of parameters being each represented by an intersection of the mathematical sets.

Preferably, the machine learning algorithm comprises a random forest machine learning algorithm.

### BRIEF DESCRIPTION OF THE DRAWINGS

The present disclosure and its advantages will be better understood by studying the detailed description of a specific embodiment given by way of a non-limiting example and illustrated by the appended drawing on which:

FIG. 1 illustrates schematically an example of a device for interpreting a prediction of at one failure of the system according to the invention.

### DETAILED DESCRIPTION

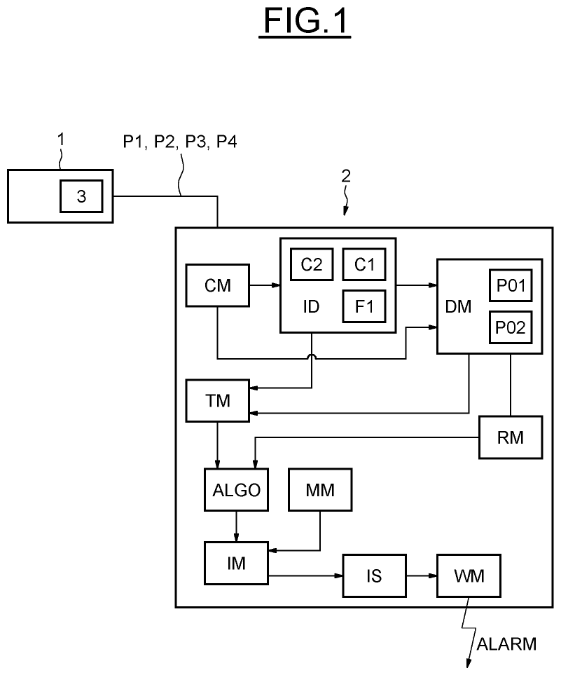

Reference is made to FIG. 1 which illustrates a system 1 and an example of a device 2 for predicting at least one failure of the system 1. The device 2 is connected to sensors 3 of the system 1 measuring a set of parameters representative of the operation of the system 1. The parameters may comprise for example a pressure, a temperature, a current, a tension, and/or a mechanical displacement.

It is assumed that the set of parameters comprises a first parameter P1, a second parameter P2, a third parameter P3 and a fourth parameter P4. However, the set of parameters may comprise less or more than four parameters.

The device 2 comprises collecting means CM for collecting the set of parameters P1, P2, P3, P4 representative of the operation of the system 1 when the system 1 is operating during a training period. The device 2 further comprises using means TM for using a trained machine learning algorithm ALGO to identify the time before a failure F1 of the system 2 occurs.

The machine learning algorithm ALGO is trained to identify the failure F1 according to the values of the set of parameters P1, P2, P3, P4. The trained machine learning algorithm ALGO is assumed to be trained to identify the parameters values leading to the failure F1. The trained machine learning algorithm ALGO may comprise for example a random forest machine learning algorithm.

The device 2 further comprises identifying means ID identifying at least two combinations C1, C2 of parameters P1, P2, P3, P4 that occurred before the appearance of the at least one failure F1 during the training period from the identified time before the failure F1 occurs. The two combinations C1, C2 each have fewer parameters than the set of parameters P1, P2, P3, P4. For example, it can be assumed that the combination C1 comprises the parameters P1, P3 and that the combination C2 comprises the parameters P1, P4.

The identifying means ID identify predictive regions comprising the parameters of the combinations C1, C2 according to their occurrence before the failure F1 occurs. The failure F1 is detected from the measured delivered by the sensors 3.

More than two combinations of parameters P1, P2, P3, P4 may be identified before the appearance of the failure F1. For example, four different combinations of parameters P1, P2, P3, P4 may be identified before the appearance of the failure F1. Moreover, the combinations C1, C2 may be identified at the appearance of more than one failure F1.

The device 2 also comprises determining means DM.

The device 2 further comprises ranking means RM ranking the identified two combinations C1, C2 of the parameters according to their probability of occurrence PO1, PO2 during the training period. The ranking means RM classify for example the two combinations C1, C2 in an ascending order. It is assumed in the following that the probability of occurrence PO1 of the combination C1 is higher than the probability of occurrence PO2 of the combination C2.

During the training period, the parameters P1, P2, P3, P4 measured by the sensors 3 are collected by the collecting means CM. The collecting means CM deliver the parameters P1, P2, P3, P4 to the training means TM to identify time before the failure F1 occurs. The time before the failure occurs is the sampling time before the failure F1 occurs.

The collecting means CM further deliver the parameters P1, P2, P3, P4 to the identifying means ID and to the determining means DM. The training means TM deliver the identified time before the failure F1 occurs to the identifying means ID. The identifying means ID determine the combinations C1, C2 of parameters P1, P2, P3, P4 occurring before the failure from the identified time and from the parameters P1, P2, P3, P4.

The identifying means ID deliver the combinations C1, C2 of parameters P1, P2, P3, P4.

The determining means DM determine the probability of occurrence PO1, PO2 of the combinations C1, C2 of parameters P1, P2, P3, P4 before the appearance of the failure F1 occurs from the combinations C1, C2 of parameters P1, P2, P3, P4 delivered by the identifying means ID and from the parameters P1, P2, P3, P4 delivered by the collecting means CM.

The combinations C1, C2 and the probability of occurrence PO1, PO2 determined by the determining means DM are delivered to the ranking means RM. The ranking means RM classify the combinations C1, C2 according to their probability of occurrence PO1, PO2.

The device 2 further comprises monitoring means MM for monitoring the set of parameters P1 to P4 of the system when the system is operating outside the training period. The device 2 also comprises implementing means IM implementing the trained machine learning algorithm ALGO with the monitored set of parameters P1 to P4 to identify the failure F1 when the system 1 is operating outside the training period.

The trained machine learning algorithm ALGO identifies the failure F1 according to the values of the set of parameters P1, P2, P3, P4. The monitoring means MM receive the parameter values delivered by the sensors 3 and transmit the values to the implementing means IM.

The implementing means IM further receive the combinations C1, C2 and the classification of the combinations C1, C2 according to their probability of occurrence PO1, PO2 from the ranking means RM. The trained machine learning algorithm ALGO is implemented by the implementing means IM to identify the failure F1 when the system 1 is operating outside the training period. As explain before, the machine learning algorithm ALGO identifies the failure F1 according to the values of the monitored set of parameters P1, P2, P3, P4.

The implementing means IM identify the combinations C1, C2 and assign a probability of occurrence determined by the ranking means to each combination C1, C2 of parameters P1, P2, P3, P4. The device 2 further comprises issuing means IS. If a monitored combination of parameters P1, P2, P3, P4 leading to the failure F1 is identified, the issuing means IS determine the combination C1 having the highest probability of occurrence PO1 of the two combinations C1, C2.

The parameters P1, P3 of the combination C1 match the monitored set of parameters P1, P2, P3, P4.

The device 1 determines the kind of failure from the detected parameter combinations indicative of a type of failure based on the history of the system before the failure appears on the system 1 to issue a combination of parameters indicative of the type of failure. The parameters of the issued combination of parameters are extracted from the detected parameters combinations. The issued combination of parameters comprises less parameters as the detected parameters combinations.

The device 2 further comprises warning means WM generating an alert ALARM comprising the combination C1 if the machine learning algorithm ALGO identifies the failure F1. The combination C1 comprising a reduced number of parameters permits the type of failure F1 to be easily determined which permits predictions to be issued for example in order to schedule preventive maintenance operations.

Each parameter P1, P2, P3, P4 is represented by a mathematical set of at least one value delivered by the sensors 3. The combination C1 of parameter P1, P2, P3, P4 is represented by an intersection of the mathematical sets. For example, each parameter P1, P2, P3, P4 is represented by an interval defined by a lower and an upper bound:

P1=[B1; B12]

P2=[B21; B22]

P3=[B31; B32]

P4=[B41; B42]

For example, the failure F1 may appear if P1 is less than B12, and P2 is between B21 and B22, and P3 is more than B31, and P4 is more than B42.

Depending on certain implementation requirements, exemplary embodiments of the various means disclosed herein may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

The device 2 and its associated means may be a programmable hardware component and can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The device 2 and its associated means, may be also implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved failure predicting methods and apparatus.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for interpreting a prediction of at least one failure of a system comprising:
collecting a set of parameters representative of an operation of the system preceding an occurrence of the at least one failure during a training period,
using a trained machine learning algorithm to identify a time before the at least one failure occurs, the time before the at least one failure occurs being a sampling time before the at least one failure occurs,
identifying at least two combinations of at least two parameters of the set of parameters occurring before an appearance of the at least one failure during the training period from the identified time before the at least one failure occurs,
determining the probability of occurrence of the at least two combinations of the at least two parameters before the appearance of the at least one failure from the set of parameters during the training period,
ranking the at least two combinations of at least two parameters according to their probability of occurrence during the training period,
monitoring the set of parameters of the system when the system is operating outside the training period,
implementing the trained machine learning algorithm with the monitored set of parameters to identify the at least one failure when the system is operating outside the training period, and
issuing the combination of the at least of two parameters before failure having the highest probability of occurrence of the at least two combinations of the at least two parameters, the combination of the at least two parameters matching the monitored set of parameters if the machine learning algorithm identifies the said failure.

2. The method according to claim 1, wherein if the machine learning algorithm identifies the at least one failure, the method comprises generating an alert comprising the combination of at least two parameters having the highest probability of occurrence before the at least one failure occurs.

3. The method according to claim 2, wherein if the alert is generated, preventive maintenance operations are scheduled.

4. The method according to claim 1, wherein the machine learning algorithm comprises a random forest machine learning algorithm.

5. The method according to claim 1, wherein collecting a set of parameters comprises receiving the set of parameters measured by at least one sensor.

6. A device for interpreting a prediction of at least one failure of a system comprising:
collecting means for collecting a set of parameters representative of the operation of the system preceding the occurrence of at the least one failure during a training period,
using means for using a trained machine learning algorithm to identify the time before the at least one failure occurs, the time before the failure occurs being the sampling time before the failure occurs,
identifying means for identifying at least two combinations of parameters of the set of parameters occurring before the appearance of the at least one failure during the training period from the identified time before the at least one failure occurs,
determining means for determining the probability of occurrence of the at least two combinations of the at least two parameters before the appearance of the at least one failure from the set of parameters during the training period,
ranking means for ranking the at least two combinations of at least two parameters according to their probability of occurrence during the training period,
monitoring means for monitoring the set of parameters of the system when the system is operating outside the training period,
implementing means for implementing the trained machine learning algorithm with the monitored set of parameters to identify the at least one failure when the system is operating outside the training period, and
issuing means for issuing the combination of the at least of two parameters before failure having the highest probability of occurrence of the at least two combinations of the at least two parameters, the combination of the at least two parameters matching the monitored set of parameters if the machine learning algorithm identifies the said failure.

7. The device according to claim 6, further comprising warning means for generating an alert comprising the combination of at least two parameters having the highest probability of occurrence before the at least one failure occurs if the machine learning algorithm identifies the at least one failure.

8. The device according to claim 6, wherein each parameter is represented by a mathematical set of at least one value, the said at least two combinations of parameters being each represented by an intersection of the mathematical sets.

9. The device according to claim 6, wherein the machine learning algorithm comprises a random forest machine learning algorithm.
